(19) United States
(12) Patent Application Publication
(10) Pub. No.: US 2022/0255138 A1
(43) Pub. Date: Aug. 11, 2022

(54) SYSTEMS AND METHODS FOR GRID SCALE ENERGY STORAGE

(71) Applicant: Ambri Inc., Marlborough, MA (US)

(72) Inventors: David J. Bradwell, Sudbury, MA (US); David A.H. McCleary, San Mateo, CA (US); Alex T. Vai, Sudbury, MA (US); Alexander W. Elliott, Billerica, MA (US); Jianyi Cui, Andover, MA (US); William Timson, Somerville, MA (US); Eliza Bishop, Boston, MA (US); William B. Langhauser, Boston, MA (US)

(21) Appl. No.: 17/679,724

(22) Filed: Feb. 24, 2022

Related U.S. Application Data
(63) Continuation of application No. PCT/US2020/050547, filed on Sep. 11, 2020.
(60) Provisional application No. 62/899,400, filed on Sep. 12, 2019.

(51) Int. Cl. H01M 10/39; H01M 4/134; H01M 4/38

(52) U.S. Cl. CPC H01M 10/399; H01M 2300/0048; H01M 4/382; H01M 4/134

(57) ABSTRACT

The present disclosure provides an energy storage device comprising a negative electrode, a molten electrolyte in electrical communication with the negative electrode, and a positive electrode in electrical communication with the molten electrolyte. One or more of the negative electrode, positive electrode, and molten electrolyte may be at least partially liquid at an operating temperature of the energy storage device. The positive electrode may be at least partially solid at the operating temperature of the energy storage device.

### CROSS-REFERENCE

This application is a continuation of International Application No. PCT/US2020/050547, filed Sep. 11, 2020, which claims the benefit of U.S. Provisional Patent Application No. 62/899,400, filed Sep. 12, 2019, which are entirely incorporated herein by reference.

### BACKGROUND

A battery is a device capable of converting chemical energy into electrical energy. Batteries are used in many household and industrial applications. In some instances, batteries are rechargeable such that electrical energy (e.g., converted from non-electrical types of energy such as mechanical energy) is capable of being stored in the battery as chemical energy, i.e., by charging the battery.

### SUMMARY

This disclosure provides energy storage devices and systems for grid scale applications. An energy storage device may include a negative electrode, an electrolyte, and a positive electrode, at least some of which may be in a liquid state during operation of the energy storage device. In some situations, during discharge of the energy storage device, an intermetallic compound forms at or near the positive electrode.

In an aspect, the present disclosure provides an energy storage device, comprising: a first electrode comprising a first material, a second electrode comprising a second material, wherein the second material comprises antimony and one or more members from the group consisting of iron, steel, and stainless steel; and an electrolyte disposed between the first electrode and the second electrode, wherein the electrolyte is configured to conduct ions of the first material.

In some embodiments, the first electrode comprises calcium. In some embodiments, the first electrode comprises an alloy of calcium and lithium. In some embodiments, the second electrode comprises a stainless steel-antimony alloy, and wherein, during discharge, the second electrode forms particles comprising (i) calcium, lithium, and antimony and (ii) one or more members selected from the group consisting of iron, steel, and stainless steel during discharge. In some embodiments, the electrolyte comprises one or more members selected from the group consisting of calcium chloride, lithium chloride, and potassium chloride. In some embodiments, the second electrode comprises an iron-antimony alloy. In some embodiments, the second electrode comprises a steel-antimony alloy. In some embodiments, the second electrode comprises a stainless steel-antimony alloy. In some embodiments, the electrolyte is a molten salt electrolyte. In some embodiments, the first electrode is at least partially liquid at an operating temperature of the energy storage device. In some embodiments, the operating temperature is greater than or equal to 250° C. In some embodiments, the second electrode comprises solid particles of the second material.

In another aspect, the present disclosure provides an energy storage device, comprising: a first electrode comprising a first material; a second electrode comprising a second material configured such that at least 80% of the second material is utilized upon discharge of the energy storage device, wherein the second material is reactive with the first material; and a molten electrolyte disposed between the first electrode and the second electrode, wherein the molten electrolyte is configured to conduct ions of the first material.

In some embodiments, the first material is in a liquid state at an operating temperature of the energy storage device. In some embodiments, the operating temperature is greater than or equal to about 250° C. In some embodiments, the first material or the second material comprise one or more metals. In some embodiments, the first material comprises calcium or a calcium alloy. In some embodiments, the second material comprises antimony. In some embodiments, the second electrode comprises particles of the second material submerged in the molten electrolyte. In some embodiments, during operation, a capacity loss of the energy storage device is less than or equal to about 0.5% over at least about 500 discharge cycles. In some embodiments, the energy storage device has a direct current to direct current (DC-DC) efficiency of greater than or equal to about 75% at a charge or discharge rate of C/4. In some embodiments, the energy storage device has a DC-DC efficiency of greater than or equal to about 80% at a charge or discharge rate of C/10.

In another aspect, the present disclosure provides an energy storage device comprising: a first electrode comprising a first material, wherein the first electrode is liquid at an operating temperature of the energy storage device; a second electrode comprising a second material that is reactive with the first material, wherein the second electrode has a charged-state specific capacity of greater than or equal to about 300 milliampere-hours per gram (mAh/g); and a electrolyte disposed between the first electrode and the second electrode, wherein the electrolyte is configured to conduct ions of the first material, and wherein the electrolyte is a molten salt.

In some embodiments, the charged-state specific capacity is greater than or equal to about 500 mAh/g. In some embodiments, the second material is a solid or semi-solid at an operating temperature of the energy storage device. In some embodiments, the operating temperature is greater than or equal to about 250° C. In some embodiments, the first material or the second material comprise one or more metals. In some embodiments, the first material comprises calcium or a calcium alloy. In some embodiments, the second material comprises antimony. In some embodiments, the second electrode comprises particles of the second material. In some embodiments, the second electrode has an energy density of greater than or equal to about 3,000 Watt-hours per liter (Wh/L).

In another aspect, the present disclosure provides an energy storage device, comprising: a container including a cavity and a lid assembly, wherein the comprises a seal that is configured to hermetically seal the cavity and withstand a force of greater than or equal to about 1000 Newtons (N) applied to the seal; and an electrochemical cell arranged within the cavity, wherein the electrochemical cell comprises a first electrode, a second electrode, and a molten electrolyte disposed between the first electrode and the second electrode.

In some embodiments, the seal is configured to withstand a force of greater than or equal to about 1400 N applied to the seal. In some embodiments, the lid assembly comprises a conductor aperture, and wherein a conductor is disposed through the conductor aperture. In some embodiments, the seal couples the conductor to the lid assembly. In some embodiments, the conductor is configured to carry up to about 200 amperes (A) of current. In some embodiments, the conductor is configured to carry greater than or equal to about 50 A of current. In some embodiments, the conductor comprises a first current collector configured to suspend the first electrode within the cavity. In some embodiments, the seal is configured to undergo greater than or equal to about 15 thermal cycles. In some embodiments, the seal comprises an aluminum nitride (AlN) ceramic and one or more thin metal sleeves. In some embodiments, the AlN ceramic is coupled to one or more thin metal sleeves via via one or more braze joints, and wherein at least one of the thin metal sleeves is joined to the lid assembly via a braze or weld joint.

In another aspect, the present disclosure provides methods for storing energy, comprising: providing an energy storage device comprising (i) a first electrode comprising a first material, (ii) a second electrode comprising a second material, wherein the second material comprises antimony and one or more members selected from the group consisting of iron, steel, and stainless steel, and (iii) an electrolyte disposed between the first electrode and the second electrode, wherein the electrolyte conducts ions of the first material; and subjecting the energy storage device to charging or discharging.

In some embodiments, the method further comprises reacting antimony with iron, steel, or stainless steel to generate the second electrode. In some embodiments, the method further comprises reacting antimony with (i) iron, steel, or stainless steel and (ii) calcium to generate the second electrode. In some embodiments, the electrolyte comprises one or more member selected from the group consisting of calcium chloride, lithium chloride, and potassium chloride. In some embodiments, the second material comprises the iron-antimony alloy. In some embodiments, the second material comprises the steel-antimony alloy. In some embodiments, the second material comprises the stainless steel-antimony alloy.

In another aspect, the present disclosure provides methods for storing energy, comprising: providing an energy storage device comprising (i) a first electrode comprising a first material, (ii) a second electrode comprising a second material, wherein the second material is reactive with the first material, and (iii) a molten electrolyte disposed between the first electrode and the second electrode, wherein the molten electrolyte is configured to conduct ions of the first material; and subjecting the energy storage device to discharging such that at least 80% of the second material is utilized.

In some embodiments, a capacity loss of the energy storage device is less than or equal to about 0.5% over at least about 500 discharge cycles. In some embodiments, the energy storage device has a direct current to direct current (DC-DC) efficiency of greater than or equal to about 65% at a charge or discharge rate of C/4. In some embodiments, the energy storage device has a DC-DC efficiency of greater than or equal to about 70% at a charge or discharge rate of C/10.

In another aspect, the present disclosure provides a method for energy storage, comprising: providing an energy storage device comprising (i) a first electrode comprising a first material, wherein the first electrode is liquid at an operating temperature of the energy storage device, (ii) a second electrode comprising a second material, wherein the second material is reactive with the first material, and (iii) an electrolyte disposed between the first electrode and the second electrode, wherein the electrolyte conducts ions of the first material, wherein the electrolyte is a molten salt, and wherein the second material has a charged-state specific capacity of greater than or equal to about 300 milliampere-hours per gram (mAh/g); and subjecting the energy device to charging or discharging.

In some embodiments, the second electrode has an energy density of greater than or equal to about 3,000 Watt-hours per liter (Wh/L). In some embodiments, the charged-state specific capacity of greater than or equal to about 500 mAh/g.

In another aspect, the present disclosure provides a method for energy storage, comprising: providing an energy device comprising (i) a container including a cavity and a lid assembly, wherein the comprises a seal that is configured to hermetically seal the cavity and withstand a force of greater than or equal to about 1000 Newtons (N) applied to the seal, and (ii) an electrochemical cell arranged within the cavity, wherein the electrochemical cell comprises a first electrode, a second electrode, and a molten electrolyte disposed between the first electrode and the second electrode; and subjecting the energy device to charging or discharging.

In some embodiments, the seal is configured to withstand a force of greater than or equal to about 1400 N applied to the seal. In some embodiments, the conductor comprises a first current collector configured to suspend the first electrode within the cavity. In some embodiments, the seal is configured to undergo greater than or equal to about 15 thermal cycles.

In another aspect, the present disclosure provides methods for forming energy storage devices, comprising: providing a cell housing comprising one or more bays and a first electrode comprising a first material, a second electrode comprising a second material, and an electrolyte, wherein the second material comprises antimony and one or more members selected from the group consisting of iron, steel, and stainless steel; loading the first material and the second material into the one or more bays of the cell housing, and loading the electrolyte into the cell housing.

In some embodiments, the first material and the second material comprise granules, and wherein each granule comprises a single component. In some embodiments, the method further comprises forming an alloy with the first material and the second material. In some embodiments, the alloy is crushed into powder or granules and the powder or granules are loaded into the one or more bays. In some embodiments, granules of the first material or the second material are combined with the electrolyte to form a molten slurry, and wherein the molten slurry is loaded into the one or more bays. In some embodiments, granules of the first material and the second material are combined with the electrolyte to form a molten slurry, and wherein the molten slurry is allowed to cool and is crushed into powder or granules and the powder or granules are loaded into the one or more bays.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### Incorporation By Reference

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates a charge and discharge process for an example electrochemical cell;

FIG. 2 illustrates open circuit voltage (OCV) measurements during charge and discharge of an example electrochemical cell;

FIG. 3 illustrates charge and discharge voltage traces for an example electrochemical cell;

FIG. 4 shows an example schematic of an electrochemical cell;

FIG. 5 shows an example of formation of a steel-antimony alloy;

FIG. 6 shows an example of voltage shifting versus capacity for charging and discharging of a battery with an antimony-based electrode;

FIG. 7 shows an example scanning electron microscope image of a steel-antimony alloy;

FIG. 8 shows an example of capacity and voltage behavior of an example electrochemical cell over a period of time;

FIGS. 9A and 9B show an example electrochemical cell; FIG. 9A shows an example housing of an electrochemical cell; FIG. 9B shows an example seal for an electrochemical cell;

FIGS. 10A and 10B show example electrochemical cell configurations; FIG. 6A shows a horizontal configuration for an example electrochemical cell; FIG. 10B shows a vertical configuration for an example electrochemical cell;

FIG. 11 shows discharge capacity for an example electrochemical cell;

FIG. 12 illustrates an example energy storage system; and

FIG. 13 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “cell” or “electrochemical cell,” as used herein, generally refers to an electrochemical cell. A cell can include a negative electrode of material ‘A’ and a positive electrode of material ‘B’, denoted as A∥B. The positive and negative electrodes can be separated by an electrolyte. A cell can also include a housing, one or more current collectors, and a high temperature electrically isolating seal.

The term “pack” or “tray,” as used herein, generally refers to cells that are attached through different electrical connections (e.g., vertically or horizontally and in series or parallel). A pack or tray can comprise any number of cells (e.g., 1, 2, 3, 4, 5, 6, 7, 8, 9, 10, 11, 12, 13, 14, 15, 16, 17, 18, 19, 20, 25, 30, 40, 50, 60, 80, 100, 120, 140, 160, 200, 250, 300 or more). In some cases, a pack or tray comprises 100 cells. In some cases, a pack is capable of storing at least about 100 kilowatt-hours of energy and/or delivering at least about 25 kilowatts of power.

The term “rack” as used herein, generally refers to packs or trays that are electrically joined together in series or parallel and may involve packs or trays that are stacked vertically on top one another. A rack can comprise any number of packs or trays (e.g., 1, 2, 3, 4, 5, 6, 7, 8, 9, 10, 11, 12, 13, 14, 15, 20, 40, 80, 100 or more). In some cases, a rack comprises 5 trays. In some cases, a rack is capable of storing at least about 500 kilowatt-hours of energy and/or delivering about 125 kilowatts of power.

The term “core,” as used herein generally refers to a plurality of packs, trays, and/or racks that are attached through different electrical connections (e.g., in series and/or parallel). A core can comprise any number of packs or trays or racks (e.g., 1, 2, 3, 4, 5, 6, 7, 8, 9, 10, 11, 12, 13, 14, 15, 16, 17, 18, 19, 20, or more). In some cases, the core also comprises mechanical, electrical, and thermal systems that allow the core to efficiently store and return electrical energy in a controlled manner. In some cases, a core comprises at least about 2 racks of at least about 10 packs or trays. In some cases, a core is capable of storing at least about 1000 kilowatt-hours of energy and/or delivering at least about 250 kilowatts of power.

The term “system,” as used herein, generally refers to one or more cores that may be attached through different electrical connections (e.g., in series and/or parallel). In some cases, the system also comprises additional electrical equipment (e.g., DC-AC bi-directional inverters), and controls (e.g., controls that enable the system to respond to external signals to change mode of operation). A system can comprise any number of cores (e.g., 2, 3, 4, 5, 6, 7, 8, 9, 10, 11, 12, 13, 14, 15, 16, 17, 18, 19, 20, or more). In some cases, a system comprises 4 cores. In some cases, a system is capable of storing about one megawatt-hours of energy and/or delivering at least about 250 kilowatts of power.

The term “battery,” as used herein, generally refers to one or more electrochemical cells connected in series and/or parallel. A battery can comprise any number of electrochemical cells, packs, trays, cores, or systems.

The term “vertical,” as used herein, generally refers to a direction that is parallel to the gravitational acceleration vector (g).

The term “cycle,” as used herein, generally refers to a charge/discharge or discharge/charge cycle. The term cycle may also refer to thermal cycling of an electrochemical cell. Thermal cycling of the electrochemical cell may include cooling and reheating cells from operating temperature to room temperature. The cells may be thermal cycled for system maintenance and/or transport of the cells.

The term “voltage” or “cell voltage,” as used herein, generally refers to the voltage of a cell (e.g., at any state of charge or charging/discharging condition). In some cases, voltage or cell voltage may be the open circuit voltage. In some cases, the voltage or cell voltage can be the voltage during charging or during discharging.

The term “oxidation state,” as used herein, generally refers to a possible charged ionic state of a species when dissolved into an ionic solution or electrolyte, such as, for example, a molten halide salt (e.g., zinc²⁺ (Zn²⁺) has an oxidation state of 2+).

The term “direct current to direct current efficiency” or “DC-DC efficiency,” as used herein, generally refers to the amount of energy, in Watt-hours (Wh), discharged from the energy storage device or battery divided by the energy, in Wh, used to charge the battery. The DC-DC efficiency may be determined using symmetric current cycling with charge and discharge voltage cut-off limits.

The term “charge-rate” or “C/‘N’,” as used herein, generally refers to the rate of charge or discharge of a battery such that the battery is fully charged or discharged of its rated capacity within ‘N’ hours. For example, a C/4 rate may indicate that the battery will be charged or discharged within four hours. A C/10 rate may indicate that the battery will be charged or discharged within ten hours.

The term “energy density,” as used herein, generally refers to the amount of energy stored in a given system or region of space per unit volume.

The term “discharge capacity,” as used herein, generally refers to the amount of electrical charge capacity (e.g., in units of amp-hours or Ah) or to the amount of energy capacity (e.g., in units of watt-hours or Wh) provided by the battery to an external electrical circuit when the battery is discharged.

The term “depth of discharge,” as used herein, generally refers to the fraction or percentage of the rated or theoretical discharge capacity of a battery that is provided to an external electrical circuit when the battery is discharged.

The term, “electrode utilization,” as used here, generally refers to the fraction or percentage of electric charge capacity (e.g., in Ah) provided by one or either electrode during a discharge process, relative to the rated or theoretical electrical charge capacity of the electrode material that was loaded into the battery.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The present disclosure provides electrochemical energy storage devices (e.g., batteries) and systems. An energy storage device may include at least one electrochemical cell sealed (e.g., hermetically sealed) within a housing or container. A cell may be configured to deliver electrical energy (e.g., electrons under a potential) to a load, such as, for example, an electronic device, another energy storage device or a power grid.

In an example, the energy storage device may supply or deliver electrical energy to a power grid. The energy storage device may receive power from a source of electrical energy, such as from an energy plant or from a renewable source of electrical energy (e.g., solar farm, wind farm, etc.). The energy storage device may be part of a system that stores energy from an intermittent renewable energy source, such as wind or solar, for delivery to a power grid.

### Energy storage devices and methods for storing energy

In an aspect, the present disclosure provides energy storage devices and methods for storing energy in an energy storage device. An energy storage device may comprise a first electrode comprising a first material, a second electrode comprising a second material, and an electrolyte disposed between the first electrode and the second electrode. The second material may include antimony (Sb) and iron, steel, stainless steel, or a combination thereof. For example, the second material may be an iron-antimony (Fe-Sb) alloy, steel-antimony alloy, or stainless steel-antimony (SS-Sb) alloy. The electrolyte may be configured to or may conduct ions of the first material. Methods for storing energy may include charging and discharging the energy storage device.

In another aspect, the present disclosure provides energy storage devices and methods for storing energy in an energy storage device. An energy storage device may comprise a first electrode, a second electrode, and a molten electrolyte. The first electrode may include a first material and the second electrode may include a second material. The first material may be reactive with the second material such that at least about 80% of the second material is utilized upon discharge of the energy storage device. The molten electrolyte may be disposed between and separate the first electrode from the second electrode. The molten electrolyte may be configured to conduct ions, or may conduct ions, of the first material. During use, the energy storage device may be subjected to charging or discharging. Methods for storing energy may include charging and discharging the energy storage device such that at least 80% of the second material is utilized during discharging.

In another aspect, the present disclosure provides energy storage devices and methods for storing energy in an energy storage device. An energy storage device may comprise a first electrode, a second electrode, and an electrolyte. The first electrode may include a first material and the second electrode may include a second material. The first electrode may be liquid or in a liquid state at an operating temperature of the energy storage device. The first material may be reactive with the second material. The electrolyte may be disposed between and separate the first electrode from the second electrode. The electrolyte may be configured to conduct ions, or may conduct ions, of the first material. The electrode may be a molten salt. The second electrode may have a charged-state specific capacity that is greater than or equal to about 300 milliampere-hours per gram (mAh/g). During use, the energy storage device may be subjected to charging or discharging. Methods for storing energy may include charging and discharging the energy storage device.

In another aspect, the present disclosure provides energy storage devices and methods for storing energy in an energy storage device. An energy storage device may include a container with a cavity and a lid assembly and an electrochemical cell arranged within the cavity. The lid assembly may include a seal that is configured to hermetically seal the cavity. The seal may be configured to withstand a force of greater than or equal to about 1000 Newtons (N) applied to the seal. The electrochemical cell may include a first electrode, a second electrode, and a molten electrolyte disposed between the first and second electrode. During use, the energy storage device may be subjected to charging or discharging. Methods for storing energy may include charging and discharging the energy storage device.

The first electrode (e.g., negative electrode) and/or the second electrode (e.g., positive electrode) may comprise one or more metals. The electrodes may comprise a single metal or multiple metals. In an example, the one or both electrodes comprise metal alloys. The first electrode may be a negative electrode (e.g., anode) and may comprise calcium (Ca) or a calcium alloy (Ca-alloy). The molten electrode may be a molten salt electrode and may include a calcium-based salt (e.g., calcium chloride). In an example, the electrolyte comprises calcium chloride and lithium chloride. In another example, the electrolyte comprises calcium chloride, lithium chloride, and potassium chloride. In another example, the electrolyte comprises calcium chloride, lithium chloride, potassium chloride, or any combination thereof. The second electrode may be a positive electrode (e.g., cathode) and may comprise antimony (Sb). The antimony may be solid particles of antimony.

In some examples, an electrochemical energy storage device includes a liquid metal negative electrode, a solid metal positive electrode, and a liquid or molten salt electrolyte separating the liquid metal negative electrode and the solid metal positive electrode. In some examples, an electrochemical energy storage device includes a solid metal negative electrode, a solid metal positive electrode, and a liquid salt electrolyte separating the solid metal negative electrode and the solid metal positive electrode. In some examples, an electrochemical energy storage device includes a semi-solid metal negative electrode, a solid metal positive electrode, and a liquid electrolyte separating the semi-solid metal negative electrode and the solid metal positive electrode.

To maintain the molten electrolyte and/or at least one of the electrodes in a liquid or semi-solid state, the battery cell may be heated to any suitable temperature. In some examples, the battery cell is heated to and/or maintained at a temperature of greater than or equal to about 100° C., 150° C., 200° C., 250° C., 300° C., 350° C., 400° C., 450° C., 500° C., 550° C., 600° C., 650° C., or 700° C., or more. In some situations, the battery cell is heated from about 150° C. to about 600° C., about 400° C. to about 500° C., or about 450° C. to about 575° C. In an example, an electrochemical cell is operated at a temperature between about 300° C. and 650° C. In another example, an electrochemical cell is operated at a temperature between about 485° C. and 525° C. In another example, an electrochemical cell is operated at a temperature of greater than or equal to about 250° C.

In an example, the energy storage device may be operated at an elevated temperature, for example, between about 450° and 550° C., to maintain the molten electrolyte and the negative electrode in a liquid state during operation of the energy storage device. Maintaining the temperature of the energy storage device may maintain the positive electrode in a solid state (e.g., pure antimony may have a melting temperature of about 630° C.). Maintaining the molten electrolyte and negative electrode in a liquid state may increase the electron-transfer kinetics of the electrodes.

In an example, the electrochemical energy storage device has an open circuit voltage (OCV) from about 0.9 volts (V) to about 1 V. The OCV of the electrochemical cell may be greater than or equal to about 0.1 V, 0.2 V, 0.3 V, 0.4 V, 0.5 V, 0.6 V, 0.7 V, 0.8 V, 0.9 V, 1 V, 1.1 V, 1.2 V, or greater. The OCV of the electrochemical cell may be from about 0.1 V to 0.2 V, 0.1 V to 0.3 V, 0.1 V to 0.4 V, 0.1 V to 0.5 V, 0.1 V to 0.6 V, 0.1 V to 0.7 V, 0.1 V to 0.8 V, 0.1 V to 0.9 V, 0.1 V to 1 V, 0.1 V to 1.1 V, 0.1 V to 1.2 V, 0.2 V to 0.3 V, 0.2 V to 0.4 V, 0.2 V to 0.5 V, 0.2 V to 0.6 V, 0.2 V to 0.7 V, 0.2 V to 0.8 V, 0.2 V to 0.9 V, 0.2 V to 1 V, 0.2 V to 1.1 V, 0.2 V to 1.2 V, 0.3 V to 0.4 V, 0.3 V to 0.5 V, 0.3 V to 0.6 V, 0.3 V to 0.7 V, 0.3 V to 0.8 V, 0.3 V to 0.9 V, 0.3 V to 1 V, 0.3 V to 1.1 V, 0.3 V to 1.2 V, 0.4 V to 0.5 V, 0.4 V to 0.6 V, 0.4 V to 0.7 V, 0.4 V to 0.8 V, 0.4 V to 0.9 V, 0.4 V to 1 V, 0.4 V to 1.1 V, 0.4 V to 1.2 V, 0.5 V to 0.6 V, 0.5 V to 0.7 V, 0.5 V to 0.8 V, 0.5 V to 0.9 V, 0.5 V to 1 V, 0.5 V to 1.1 V, 0.5 V to 1.2 V, 0.6 V to 0.7 V, 0.6 V to 0.8 V, 0.6 V to 0.9 V, 0.6 V to 1 V, 0.6 V to 1.1 V, 0.6 V to 1.2 V, 0.7 V to 0.8 V, 0.7 V to 0.9 V, 0.7 V to 1 V, 0.7 V to 1.1 V, 0.7 V to 1.2 V, 0.8 V to 0.9 V, 0.8 V to 1 V, 0.8 V to 1.1 V, 0.8 V to 1.2 V, 0.9 V to 1 V, 0.9 V to 1.1 V, 0.9 V to 1.2 V, 1 V to 1.1 V, 1 V to 1.2 V, or 1.1 V to 1.2 V. The OCV may depend upon the state of charge. This OCV may be less than the OCV of lithium-ion type batteries. An OCV in this range may reduce the risk of thermal run away, allow for the production of larger cells, and reduce the complexity of the battery management system as compared to batteries with a higher OCV. The effect of the lower open circuit voltage may be at least partially offset by the cell chemistry, for example, both calcium and antimony may exchange multiple electrons.

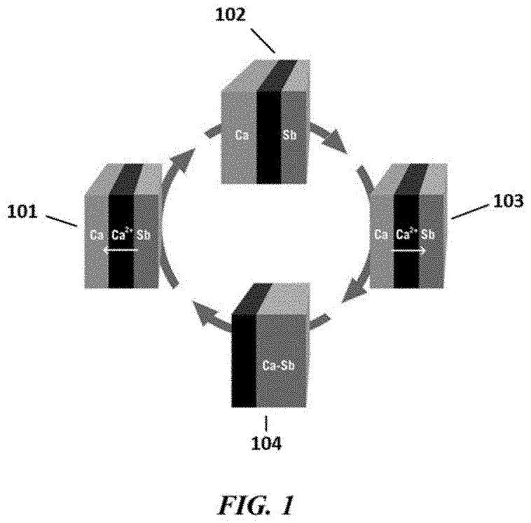

FIG. 1 shows an example of an energy storage device during charging 101, in a charged state 102, discharging 103, and in a discharged state 104. In the charged state 102, the anode may be a liquid calcium (Ca) alloy, the electrolyte may comprise calcium ions (Ca²⁺), and the positive electrode (e.g., cathode) may comprise solid antimony (Sb) particles. Discharging 103 of the electrochemical cell may consume the negative electrode (e.g., anode). When the cell is discharging 103, half-reactions may occur at each electrode. At the negative electrode (e.g., anode), the Ca alloy may release electrons and dissolve into the salt as an ion (e.g., xCa→xCa²⁺+2xe⁻). The electrons may travel through an external circuit where they perform electrical work. At the positive electrode (e.g., cathode), ions from the molten salt may combine with Sb metal in the cathode and electrons returning from the external circuit to form an intermetallic compound (e.g., Sb+xCa²⁺+2xe⁻→CaₓSb_{(alloy)}). The driving force for the electron to flow between the electrodes (via an external circuit) may be the relative activity of Ca between the negative electrode and the positive electrode. The activity of Ca in the anode may be close to 1, while the activity of Ca in the Sb cathode may be 3×10⁻¹¹ to 3×10⁻¹³. The two cell-discharging half-reactions may combine into a full reaction (e.g., xCa+Sb→CaₓSb_{(alloy)}).

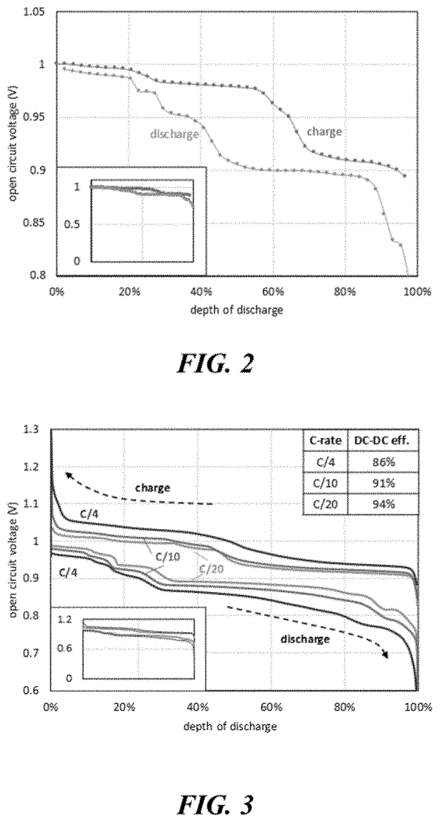

FIG. 2 illustrates open circuit voltage (OCV) measurements during charge and discharge of an example electrochemical cell. The discharge voltage measurements show multiple plateaus, which may represent the different redox reactions as antimony atoms from different intermetallic compounds (e.g., CaₓSb_{(alloy)}). During discharge, each Ca atom may donate two electrons and each Sb atom may accept three electrons. Both the anode and cathode may be ‘polyvalent’, which may increase the electrode capacity density. The capacity density (based on the surface area of the cathode that is orthogonal to the average flow of ions through that surface area) of the second electrode may be greater than or equal to about 0.1 ampere hour per square centimeter (Ah/cm²), 0.2 Ah/cm², 0.3 Ah/cm², 0.4 Ah/cm², 0.5 Ah/cm², 0.6 Ah/cm², 0.7 Ah/cm², 0.8 Ah/cm², or more. The capacity density of the second electrode may be between about 0.1 Ah/cm² and 0.2 Ah/cm², 0.1 Ah/cm² and 0.3 Ah/cm², 0.1 Ah/cm² and 0.4 Ah/cm², 0.1 Ah/cm² and 0.5 Ah/cm², 0.1 Ah/cm² and 0.6 Ah/cm², 0.1 Ah/cm² and 0.7 Ah/cm², or 0.1 Ah/cm² and 0.8 Ah/cm². In an example, the capacity density of the second electrode is between about 0.16 Ah/cm² and 0.78 Ah/cm². The capacity volumetric density of the second electrode may be greater than or equal to about 0.1 ampere hour per milliliter (Ah/mL), 0.2 Ah/mL, 0.3 Ah/mL, 0.4 Ah/mL, 0.5 Ah/mL, 0.6 Ah/mL, 0.7 Ah/mL, 0.8 Ah/mL, 0.9 Ah/mL, 1 Ah/mL, 1.25 Ah/mL, or 1.5 Ah/mL.

The charge and discharge processes described in FIG. 1 may exhibit some hysteresis. However, the cells may achieve commercially practical values for direct current to direct current (DC-DC) energy efficiency. For example, cells with about a 20 ampere-hour (Ah) capacity have shown approximately a 99% Coulombic efficiency and 86%, 91%, and 94% DC-DC efficiency for C/4, C/10, and C/20 charge rate, respectively, achieving an average cell discharge voltage of approximately 0.85 V. FIG. 3 illustrates charge and discharge voltage traces for an example electrochemical cell. Utilization of Ca and Sb electrodes may be greater than or equal to about 90%. In FIG. 3, the ‘100% depth of discharge’ value is based upon 90% utilization of Sb assuming three electrons per Sb atom.

DC-DC efficiency values may be influenced by the cell configuration, such as electrode thickness/capacity and inter-electrode spacing which may alter the current density (at a given charge rate) and internal resistance, respectively, both of which may change overpotentials and impact DC-DC efficiency. The DC-DC efficiency of an electrochemical cell may be greater than or equal to about 60%, 65%, 70%, 75%, 80%, 85%, 90%, 95%, or greater at a charge/discharge rate of C/4. In an example, the DC-DC efficiency is greater than about 75% at a charge/discharge rate of C/4. In an example, the DC-DC efficiency is greater than about 65% at a charge/discharge rate of C/4. The DC-DC efficiency of an electrochemical cell may be greater than or equal to about 60%, 65%, 70%, 75%, 80%, 85%, 90%, 95%, or greater at a charge/discharge rate of C/10. In an example, the DC-DC efficiency is greater than about 80% at a charge/discharge rate of C/10. In an example, the DC-DC efficiency is greater than about 70% at a charge/discharge rate of C/10.

Electrode utilization may include dissolution of ions of one electrode into the electrolyte and reaction of ions from the electrolyte with material of the other electrode. For example, the second electrode or cathode may be utilized (e.g., reacted with ions of the first material) during discharge of the electrochemical cell. Utilization of the second electrode may be greater than or equal to about 50%, 60%, 70%, 80%, 90%, or more during discharge. In an example, utilization of the second electrode may be greater than or equal to about 70% during discharge. In another example, utilization of the second electrode may be greater than or equal to about 80% during discharge. In another example, utilization of the second electrode may be greater than or equal to about 90% during discharge. Electrode utilization may be altered or otherwise modified by various features, operating parameters, or both. Parameters that may alter or modify electrode utilization may include, but are not limited to, the design of the porous metal separator (e.g., thickness, material, pore size, etc.), design of the negative current collector (e.g., thickness, material, pore size, etc.), operating temperature, charge rate, electrode thickness, electrode shape, positive electrode particle size, electrolyte composition, electrolyte thickness, distance between the negative and positive electrodes, charge cut-off voltages, or any combination thereof. For example, electrode utilization may be increased by reducing a thickness of the electrodes (e.g., negative electrode thickness or particle size of the positive electrode), reducing a thickness of the electrolyte disposed between the electrodes, use of electrodes with a large surface area (e.g., greater than or equal to about 10 square centimeters (cm²)), operated at a charge rate of C/4 or slower at constant current rate, or any combination thereof. In an example, an electrochemical cell comprising a plurality of negative electrodes each with a thickness of less than or equal to about 0.5 centimeters, electrolyte gap between the electrodes of less than or equal to about 10 millimeters, and negative electrodes that are flat in shape and disposed parallel to one another with a surface area of greater than or equal to about 10 cm² operated at C/4 or slower may have an electrode utilization of greater than or equal to about 80%.

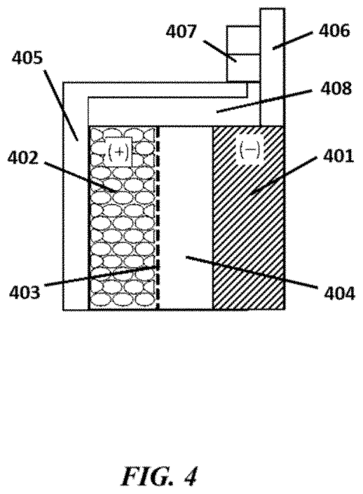

FIG. 4 shows a schematic of an example electrochemical cell configuration. In the example, the Ca alloy negative electrode 401 is held within a porous metal current collector. The positive electrode 402 comprises solid antimony particles that are held in place with a permeable metal separator 403, which may also serve as the positive current collector. The particles may be submerged in or surrounded by the molten electrolyte 404. The negative electrode 401, positive electrode 402, and molten electrolyte 404 may be contained within a cell housing 405. The cell housing 405 may be in electrical communication with the permeable metal separator 403 and may serve as the positive current collector. The cell housing may have an aperture with a negative current lead 406 extending through into the cell housing 405. The negative electrode 401 may be in electrical communication with the negative current lead 406. The cell housing may be hermetically sealed by a seal 407 disposed between the negative current lead 406 and the cell housing 405. The positive electrode 402, negative electrode 401, and electrolyte 404 may be arrange within the cell housing 405 such that an empty headspace 408 is present above the cell components.

A calcium-antimony (Ca∥Sb) battery may use as the negative electrode active material a liquid Ca metal alloy. The negative electrode may further include one or more alloying additives. When Ca metal converts to Ca²⁺ ion the reaction involves the exchange of two electrons per atom. In an example, and assuming 90% anode utilization, a pure Ca electrode with a density of 1.55 g/mL may have a specific capacity of about 1200 milliampere-hours per gram (mAh/g) and a capacity density of about 1850 milliampere-hours per milliliter (mAh/mL). Assuming 0.85 V, these ampere-hour-based values translate into a specific energy of approximately 1023 watt-hours per kilogram (Wh/kg) and an energy density of approximately 1659 watt-hour per liter (Wh/L), respectively. For the negative electrode to exist as a liquid at the cell operating temperature, Ca may be alloyed with other materials. This may modify the energy and capacity values reported above.

The second electrode or cathode may have a charge-state specific capacity of greater than or equal to about 50 milliamp-hours per gram (mAh/g), 100 mAh/g, 150 mAh/g, 200 mAh/g, 250 mAh/g, 300 mAh/g, 400 mAh/g, 500 mAh/g, 600 mAh/g, 800 mAh/g, 1000 mAh/g, or more. In an example, the cathode has a charge-state specific capacity of greater than or equal to about 200 mAh/g. In an example, the cathode has a charge-state specific capacity of greater than or equal to about 300 mAh/g. In an example, the cathode has a charge-state specific capacity of greater than or equal to about 500 mAh/g. The charge-state specific capacity of the cathode may be altered or modified by features and operating conditions of the electrochemical cell. Parameters that may alter or modify the charge-state specific capacity of the cathode may include, but are not limited to, the particle size of the positive electrode, thickness of the positive electrode, electrolyte, electronic connection with the positive current collector, charge rate, or any combination thereof. In an example, the charge-state specific capacity of the cathode may be greater than or equal to about 300 mAh/g and the positive electrode may comprise particles (e.g., antimony particles) with a characteristic dimension of less than or equal to 1 millimeter surrounded by molten electrolyte. In another example, the charge-state specific capacity of the cathode may be greater than or equal to about 300 mAh/g and the positive electrode may comprise particles (e.g., antimony particles) with a characteristic dimension of less than or equal to 100 micrometers surrounded by molten electrolyte. In another example, the charge-state specific capacity of the cathode may be greater than or equal to about 300 mAh/g and the positive electrode may be in electronic communication to the current collector via a network structure (e.g., the particles may form a network structure). In another example, the charge-state specific capacity of the cathode may be greater than or equal to about 300 mAh/g and the positive electrode may have a thickness of less than or equal to about 2.5 centimeters. In another example, the charge-state specific capacity of the cathode may be greater than or equal to about 300 mAh/g and the electrochemical cell may be operated with a charge rate of less than or equal to (e.g., slower than) C/4. Operating a cell at a rate higher than (e.g., faster than) C/4 may reduce the charged-state specific capacity during operation.

The cathode may have an energy density that is greater than or equal to about 2000 watt-hours per liter (Wh/L), 2250 Wh/L, 2500 Wh/L, 2750 Wh/L, 3000 Wh/L, 3250 Wh/L, 3500 Wh/L, 3750 Wh/L, 4000 Wh/L, or greater. In an example, the cathode has an energy density of greater than or equal to about 2750 Wh/L. In another example, the cathode has an energy density of greater than or equal to about 3000 Wh/L.

The use of a liquid metal anode alloy may avoid certain electrode failure modes, such as crack formation and electric disconnection present in other cell chemistries. Furthermore, chemistries comprising a solid metal negative electrode (e.g., lithium metal, or zinc-based chemistries) may form dendrites when the negative metal is plated during charging, resulting in cell shorting and the potential for thermal runaway. By contrast, liquid metals suppress dendrite formation due to their high surface tension and rapid transport properties. The liquid anode may be held in place by taking advantage of the anodes ability to wet other metals, such as stainless steel or other ferrous alloys. By using a porous metallic structure as the negative current collector, the liquid metal anode may wick into the negative current collector, similar to water wicking into a sponge.

The electrolyte may comprise industrial grade CaCl₂ and other salts. As cells operate at an elevated temperature, the electrolyte may be a molten salt mixture that is non-aqueous (i.e., no water), so there is no risk of hydrogen gas generation, release, or ignition, as has been experienced with water-based cell chemistries. If overcharged, side-reactions may occur within the cell (e.g., the dissolution of Sb into the salt as Sb³⁺). However, these side-reactions may not result in electrolyte decomposition or the production of gaseous species. The salts may be non-flammable, so there may be no risk of ignition or catching fire. Although the molten salt is non-aqueous, it may be a clear, a low-viscosity liquid that appears visually similar to water.

The positive electrode may utilize solid particles (e.g., antimony particles) surrounded by molten salt and held in place by a permeable metal separator. The use of small (<1 cm) solid particles may provide a shorter diffusion path length and a corresponding increase in utilization and/or accessibility of positive electrode material compared to other cell designs that use a layer of liquid positive electrode. For example, batteries using a calcium-magnesium negative electrode and liquid antimony positive electrode (Ca—Mg∥Sb_{liq}) cells operating at 650° C. may have a theoretical capacity of about 23 mole percent (mol %) Ca in Sb and may experimentally achieve about 90% of that theoretical capacity, thus representing about 0.54 electrons per Sb atom. In contrast, by using small solid Sb particles in the Ca∥Sb cell chemistry, each Sb particle can accept three electrons, and greater than about 90% utilization of the Sb has been demonstrated, thus representing a five-fold increase in capacity of the Sb cathode material compared to using a liquid Sb metal cathode.

The cathode material may be combined or mixed with the molten electrolyte. The cathode material and salt mixture may be held in a cathode chamber using a permeable metal separator which may allow for ion transport between the bulk (inter-electrode) salt region and the cathode chamber and also may serve as a positive current collector. The solid particles (e.g., antimony particles) may be electronically conductive, enhancing their ability to participate in charging and discharging reactions. Even without the use of additives to enhance electrical conductivity of the mixture, cell may regularly access 90% of the loaded Sb capacity, based on each Sb atom accepting three electrons.

An antimony cathode may have a high volumetric energy density. For example, antimony has a density of 6.7 grams per milliliter (g/mL). With each Sb atom accepting three electrons, the theoretical specific capacity of Sb may be 660 mAh/g and the capacity density for Sb may be 4,400 mAh/mL. With 90% utilization of the electrode material, capacity values may be in the range of 600 mAh/g and 4,000 mAh/mL. At a nominal discharge voltage of 0.85 V, these values may translate to a specific energy of about 505 Wh/kg and an energy density of about 3,385 Wh/L. Table 1 shows a comparison of these cathode performance metrics against an example lithium-ion battery chemistry.

TABLE 1
comparison of cathode performance metrics

| | Lithium-ion, | | % Different vs. |
|---|---|---|---|
| | NMC 111 | Ca ∥ Sb | NMC 111 |
| Charged state cathode | Li_{1-0.61}Co_{1/3}Ni_{1/3}Mn_{1/3}O₂ | Sb | |
| Theoretical specific capacity (mAh/g) | 299 | 660 | +121% |
| Theoretical capacity density (mAh/mL) | 1425 | 4,400 | +209% |
| Density (g/mL) | 4.76 | 6.7 | +41% |
| Open Circuit Voltage (V) | 3.7 | 0.95 | −75% |
| Typical specific capacity (mAh/g) | 178 | 594 | +234% |
| Typical capacity density (mAh/mL) | 732 | 3,982 | +444% |
| Typical specific energy (Wh/kg) | 658 | 505 | −23% |
| Typical energy density (Wh/L) | 2,709 | 3,385 | +25% |

Thus, the charged-state Sb cathode may have an advantage of 234% and 444% for the specific capacity and capacity density, respectively, versus the charged state of an example lithium-ion battery cathode. The high ampere-hour (Ah) capacity of the cathode may be partially offset by the relatively low cell voltage of metal/metalloid couples such as Ca∥Sb, resulting in a 23% lower specific energy and a 25% higher energy density as compared to the charged state of the example lithium-ion battery cathode. The Sb cathode may have the ability to store a high of Ah-capacity within a small volume, based on its ability to accept three electrons per Sb atom (rather than <1 electron per mole of Li_{1-0.61}Co_{1/3}Ni_{1/3}Mn_{1/3}O₂).

The positive electrode may be reactive with the cell housing (e.g., container). For example, the positive electrode (e.g., second electrode) may comprise antimony and the antimony may react with the iron, steel, or stainless steel of the cell housing. Reactions between the material of the second electrode (e.g., antimony) and the components of the cell housing may occur during operation and may form an iron-, steel-, or stainless steel-antimony alloy. The reaction may be spontaneous or may take multiple charge and discharge cycles to form an iron-antimony, steel-antimony, or stainless steel-antimony alloy.

In an example, the electrochemical energy storage device may include a positive electrode comprising antimony. The positive electrode may react with cations from the electrolyte (e.g., calcium or lithium ions) to form one or more transitional products (e.g., CaSb₂ and/or LiCaSb). Additionally, or alternatively, the positive electrode may react with the cell housing (e.g., steel or stainless steel components) to generate an alloy comprising antimony and iron (Fe), steel, or stainless steel (SS). Reactions between the positive electrode (e.g., antimony) and cell housing may form Fe—Sb, steel-Sb, or stainless steel-Sb alloys in a fully charged state. In a discharged state, the positive electrode may phase separate into Fe, steel, or stainless steel and LiCaSb.

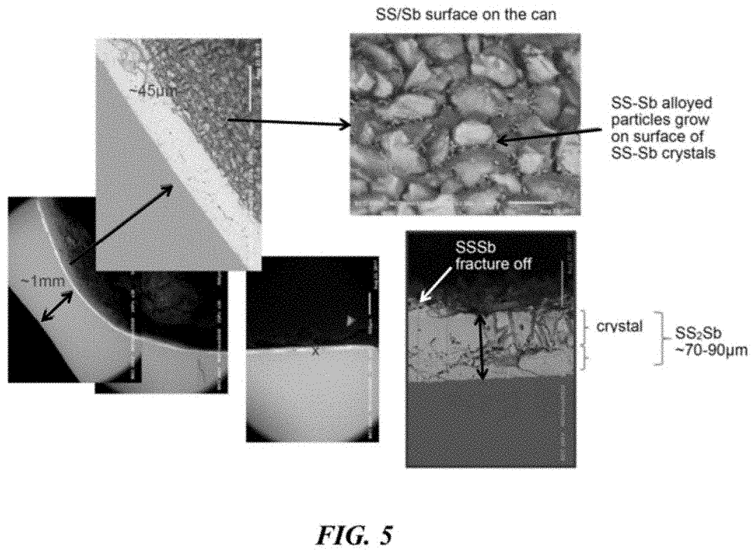

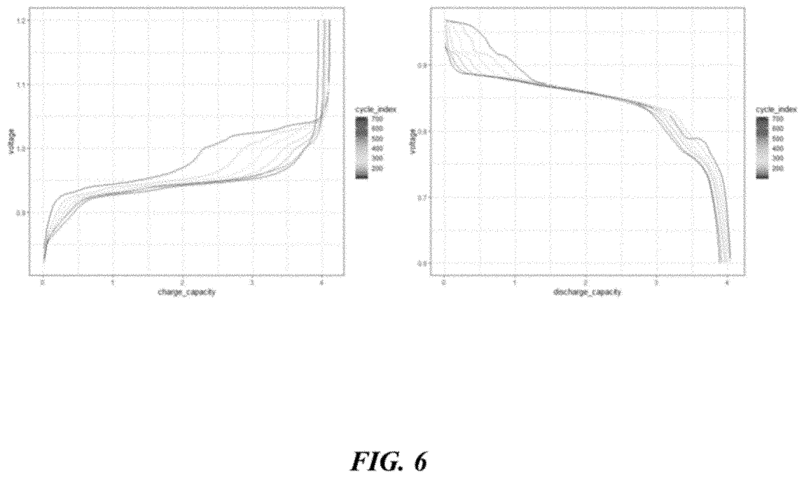

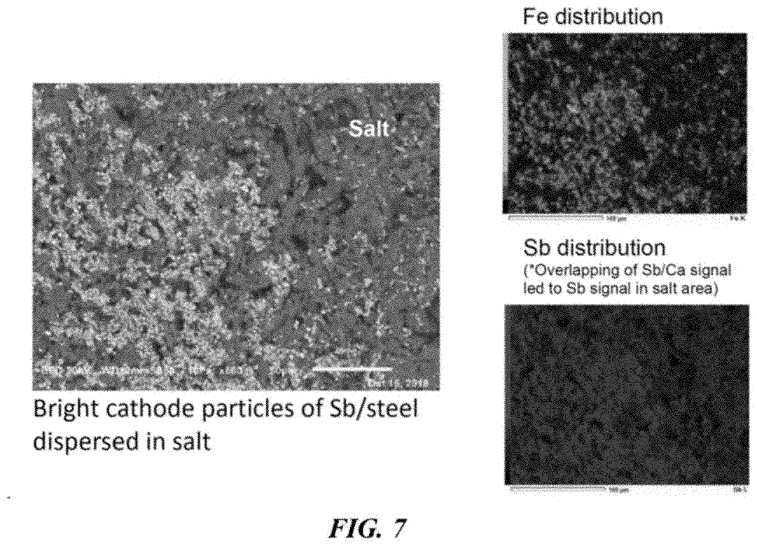

FIG. 5 shows an example chemical reaction between the antimony and a stainless steel container. As shown in FIG. 5, SS-Sb alloyed particles may form on a surface of the cell housing, other housing components (e.g., porous metal separator), positive electrode particles, or any combination thereof. The antimony alloy particles may remain on the surface or may fracture off of the surface. Formation of the iron-, steel-, or stainless steel-alloy from the cell housing may be correlated with a shift in the electrochemical voltage profile during cycling. As shown in FIG. 6, the voltage as a function of charge capacity may decrease as the number of charge/discharge cycles increases. An example of the positive electrode particles reacted with steel is shown in FIG. 7. shows example scanning electron microscope images of the positive electrode species after approximately 5000 hours of operation. The white portion of the image may correspond to steel-antimony alloy particles dispersed in a salt electrolyte.

Reactions between the positive (e.g., antimony) electrode and the cell housing components (e.g., steel or stainless steel components) may decrease the electrochemical and structural stability of the electrochemical cell. For example, during prolonged periods of operations, the steel or stainless steel and antimony alloying reaction may consume steel or stainless steel from the structural components of the electrochemical cell. In an electrochemical cell with a porous metal separator that hold the positive electrode in place, the positive electrode (e.g., antimony) may react with the porous metal separator. The steel or stainless steel antimony alloying reaction may degrade components of the cell, such as the porous metal separator. Degradation of the porous metal separator may lead to loss of containment of the positive electrode, potentially resulting in an apparent loss of cell capacity (e.g., see FIG. 6) and formation of internal shorting within the cell.

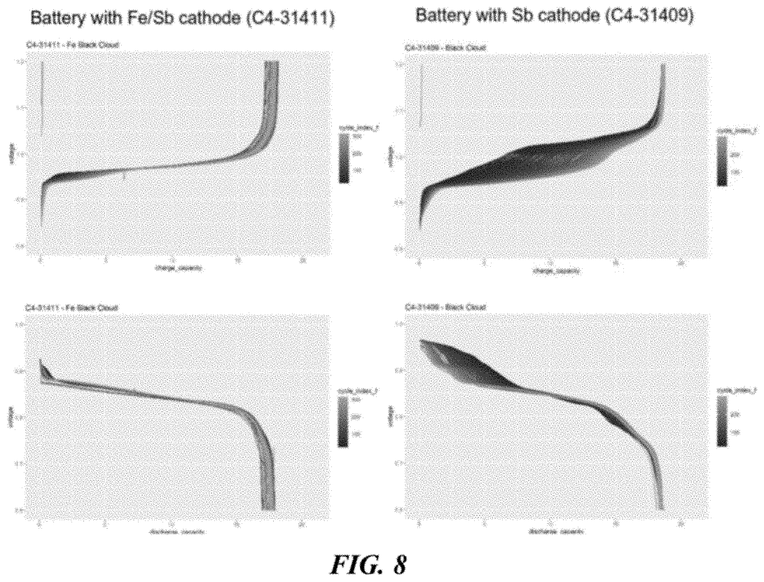

Reactions between the positive (e.g., antimony) electrode and the cell housing components (e.g., steel or stainless steel components) may be prevented or at least partially prevented by using pre-alloyed or pre-mixed positive electrode compositions, such as iron (Fe)-antimony (Sb) alloys, steel-Sb alloys, or stainless steel (SS)-Sb alloys. As shown in FIG. 8, pre-alloying or pre-mixing the positive electrode material (e.g., antimony) with iron, steel, or stainless steel may slow or prevent degradation of the steel or stainless steel components as compared to electrochemical cells without pre-alloying or pre-mixing the positive electrode material with the iron, steel, or stainless steel and enhance stability of the electrochemical cell over time. Additionally, electrochemical cells built with steel or stainless steel additions may exhibit less shift in the cell voltage over time, which may permit simpler control algorithms to predict state of health and state of charge of the cells.

The energy storage device may include a container or housing with a lid assembly. The lid assembly may include a seal that hermetically seals the electrochemical cell within the housing or container. The seal may be mechanically robust and may comprise chemically stable materials. The mechanical seal may be configured to survive (e.g., maintain hermetic sealing) for hundreds of thermal cycles. In the housing, the negative and positive portion of the cell may be electrically separated (e.g., by the electrolyte) to avoid shorting of the electrodes. The electrochemical energy storage device may include a positively polarized stainless steel housing and lid assembly, a negatively polarized metal current lead (NCL) rod (e.g., conductor) that passes through a hole in the lid assembly, and a seal component (e.g., FIG. 4). The seal component may join the NCL rod to the cell lid. The conductor, or negative current lead, may carry up to about 50 amperes (A), 75 A, 100 A, 125 A, 150 A, 200 A, 250 A, 300 A, 400 A, 500 A, or more of current when the cell is charging or discharging. In an example, the conductor may carry up to 200 amperes (A) of current when the cell is charging or discharging. The conductor, or negative current lead, may greater than or equal to about 50 amperes (A), 75 A, 100 A, 125 A, 150 A, 200 A, 250 A, 300 A, 400 A, 500 A, or more of current when the cell is charging or discharging. In an example, the conductor may carry greater than or equal to about 100 amperes (A) of current when the cell is charging or discharging.

The seal may be electrically insulating or may be at least partially electrically insulating. The seal may be gas-tight and hermetically seal the housing of the energy storage device. The seal may prevent air from entering the cell (which may lead to cell performance degradation). Due to the high operating temperature of the cell, the exposure to air (on the external side) and molten salt and reactive metal vapors (on the internal side), the number of options for seal materials and designs may be limited.

Seal materials may be selected based on the resistance of the raw materials to reactivity with calcium metals and molten salts. Material selection may also be informed by thermodynamic analysis and corrosion testing. In an example, a seal may comprise a ceramic-to-metal brazed assembly comprising an aluminum nitride (AlN) ceramic. The AlN ceramic may be resistant to chemical reaction with the reactive material of the cell (e.g., calcium metal or molten electrolyte). The AlN ceramic may be coupled to thin metal sleeves via a ceramic-to-metal braze. The thin metal sleeves may be coupled to the housing of the electrochemical cell or the conductor via a weld or a braze joint. The seal may include a unique combination of the AlN ceramic, braze, and stainless steel sleeves, which each have significantly different coefficients of thermal expansion (i.e., they expand and contract different amounts when they are heated and cooled).

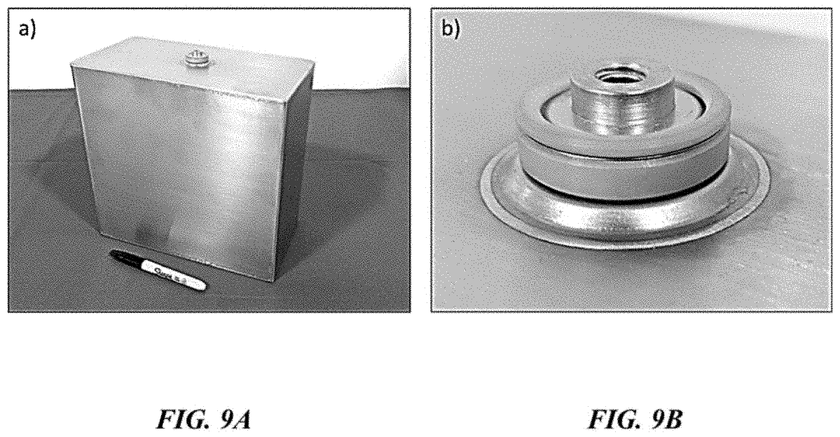

The seal may be designed for high volume manufacturing and may include three flat ceramic washers which sandwich two thin metal sleeves. One metal sleeve may connect to the negative current lead rod and the other may connect to cell lid. The thin metal sleeves may be brazed on their top and bottom sides to two of the ceramic washers. FIGS. 9A and 9B show an example electrochemical cell. FIG. 9A shows an example housing of an electrochemical cell. FIG. 9B shows an example seal for an electrochemical cell. The seal may be configured to survive (e.g., maintain the hermetic seal of the housing) hundreds of rapid thermal cycles (e.g., heating from room temperature to cell operating temperature). For example, the seal may be configured to survive or may survive greater than or equal to 10, 15, 20, 25, 30, 40, 60, 80, 100, 150, 200, 300, 400, 600, 800, 1000, or more thermal cycles. In an example, the seal may be configured to survive or may survive greater than 15 thermal cycles.

The seal may be configured to be or may be mechanically robust. The seal may be configured to withstand a compressive (e.g., downward force) or a pull force. The seal may be configured to withstand a force of greater than or equal to about 100 Newtons (N), 200 N, 300 N, 400 N, 500 N, 600 N, 800 N, 1000 N, 1200 N, 1400 N, 1600 N, 1800 N, 2000 N, or more. In an example, the is configured to withstand a force (e.g., compressive or pull force) of greater than or equal to about 1000 N. In an example, the is configured to withstand a force (e.g., compressive or pull force) of greater than or equal to about 1400 N.

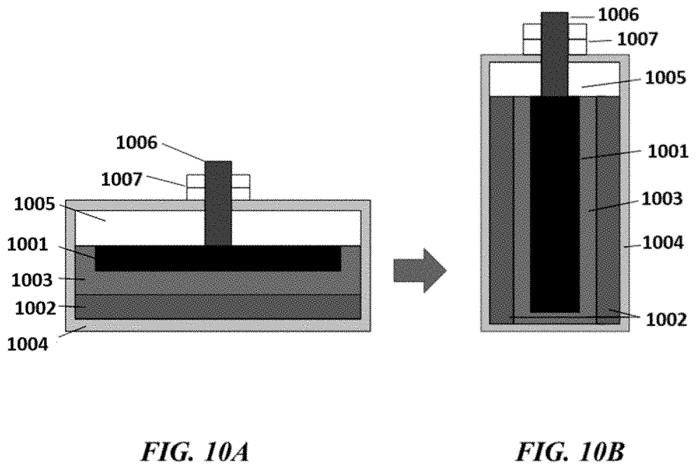

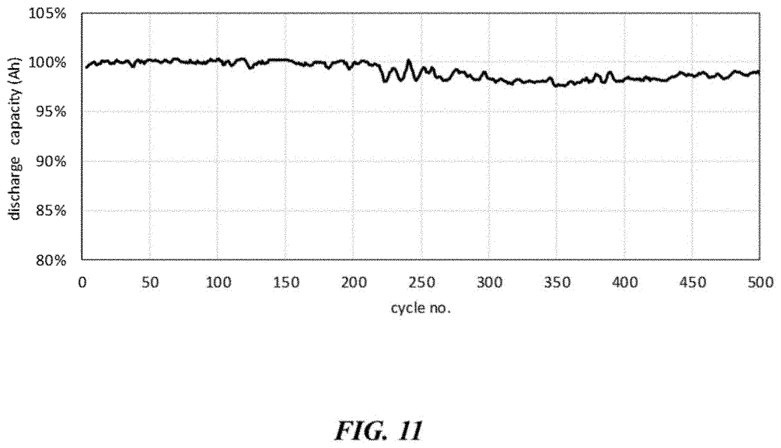

The cell may be configured or arranged in a horizontal configuration or a vertical configuration. FIG. 10A shows an example of an electrochemical cell arranged in a horizontal configuration. The horizontal configuration may have three layers (e.g., negative electrode 1001 and positive electrode 1002 separated by an electrolyte 1003) that are disposed on top of one another. Each layer of the three layer design may be approximately 1 centimeter (cm) thick. The cell housing 1004 may have a larger width and depth than the height of the cell. The cell housing 1004 may include an empty headspace 1005 above the electrodes and electrolyte. The cell housing 1004 may include an aperture with a negative current lead 1006 sealed to the housing 1004 by a seal 1007. In an example, the two electrodes and electrolyte are liquid at an operating temperature of the cell and float on top of one another based on density differences and immiscibility in the horizontal configuration. The horizontal configuration, for example, may have a DC-DC efficiency of approximately 80% and may charge/discharge within about 4 hours (hrs) to 12 hrs. The cell capacity using the horizontal configuration may be increased by increasing the lateral dimensions of the cell. The increased lateral dimensions may decrease packing efficiency and increase size and weight of cell-to-cell interconnections.

The cell may be configured or arranged in a vertical configuration. FIG. 10B shows and example electrochemical cell arranged in vertical configuration. The vertical configuration may comprise multiple layers of negative electrode 1001 and positive electrode 1002 arranged in each cell and separated by an electrolyte 1003, thereby permitting for a tall rectangular or prismatic cell design. The cell housing 1004 may include a conductor (e.g., negative current lead) 1006 extending through a seal 1007 in the cell housing 1004. The conductor 1006 may act as the negative terminal and may be in contact with a negative current collector. The conductor 1006 may comprise the negative current collector. The conductor may be configured to or may suspend the first electrode (e.g., negative electrode) 1001 within the cavity of the container. The tall rectangular or prismatic cell design may permit shorter and lighter cell-to-cell interconnects and higher packing efficiency within trays and racks as compared to the horizontal cell design. The vertical configuration may be less sensitive to tilt and vibration as comparted to the horizontal configuration. Each cell may have a capacity of greater than or equal to about 100 ampere-hours (Ah), 200 Ah, 300 Ah, 400 Ah, 600 Ah, 800 Ah, 1000 Ah, 1200 Ah, 1400 Ah, 1600 Ah, 1800 Ah, 2000 Ah, or more. A plurality of electrochemical cells may pack into trays that may be loaded into a rack system. As the cells may not experience thermal runaway, a plurality of cells may be packed closely together within a system to increase the system-level energy density. The vertical configuration may also permit larger cells than the horizontal configuration which may reduce the number of balancing and/or sensing wire connections and overall circuitry of the system, which may reduce the complexity of the system.

The Ca∥Sb cell chemistry has shown robust cycling performance, including low capacity fade under full depth of discharge cycling, projecting to decades of operation. An example of the cycling performance of an example cell is shown in FIG. 11. The example cell shows a capacity loss of less than 0.5% over 500 depth of discharge cycles at a cycling rate of C/3 and 90% cathode utilization. An electrochemical energy storage device may be configured with less than or equal to about 10%, 7.5%, 5%, 4%, 3%, 2%, 1%, 0.5%, or less capacity fade (e.g., reduction in capacity) over a twenty-year period of daily cycling. The electrochemical cells may be configured to undergo thermal cycling without a reduction in cell capacity. For example, the electrochemical cells may be thermal cycled at least 5, 10, 20, 30, 40, 50, 60, 80, 100, 120, 150, 200, or more time without impacting cell cycling performance (e.g., capacity fade of less than 0.5%). Parameters that may modify or alter cycling performance may include, but are not limited to, robustness and longevity of the hermetic seal, porous metal separator (e.g., separator remains intact over the life of the cell), or a combination thereof.

### Methods for Manufacturing an Energy Storage Device

In another aspect, the present disclosure provides for methods of forming an energy storage device. The method for forming the energy storage device may include providing a cell housing comprising one or more bays, a first electrode comprising a first material, a second electrode comprising a second material, and an electrolyte, loading the first material and the second material into the one or more bays of the cell housing, and loading the electrolyte into the cell housing. The second material may comprise antimony (Sb) and iron (Fe), steel, stainless steel (SS), or a combination thereof. The electrolyte may be a molten salt.

The one or more bays may be formed by one or more porous separators disposed within the cell housing. The one or more porous separators may comprise steel or stainless steel and may be welded, brazed, or otherwise joined an internal surface of the cell housing. Cell assembly may include providing precursor materials, such as materials that form the first electrode, second electrode, and electrolyte. The precursor materials may be materials comprised predominantly of a single component (e.g., calcium, antimony, iron, steel, stainless steel, etc.). Alternatively, or in addition to, the precursor materials may be alloys of multiple components (e.g., iron-antimony alloy or calcium-antimony alloy).

The first material and second material may be loaded within the cell as separate granules (e.g., Ca and Sb granules) and the cell may be filled with the electrolyte such that the granules are submerged within the electrolyte. In an example, granules of iron, steel, or stainless steel may also be added with the granules of the first and second materials. Alternatively, or in addition to, the first material and the second material may be pre-reacted together to form a discharged state positive electrode (e.g., cathode). In an example, the first material and second material may be pre-reacted with iron, steel, or stainless steel to form the discharged state positive electrode (e.g., cathode).

In an example, the electrochemical cell is formed by loading the one or more bays of the cell with separate granules or particles of the first material (e.g., calcium (Ca)) and the second material (e.g., Sb, and Fe, steel, or SS). The second material may comprise separate granules of antimony and iron, steel, or stainless steel. Alternatively, or in addition to, the second material may comprise pre-alloyed granules of antimony and iron, steel, or stainless steel. The cell may be filled with the molten salt electrolyte such that the granules or particles are submerged within the molten salt electrolyte.

In another example, the first material (e.g., Ca) and the second material (e.g., Sb and Fe, steel, or SS) may be pre-reacted to form an alloy. The alloy may be crushed to generate a powder or granules of the alloy. The powder or granules may be loaded into the one or more bays. The cell may be filled with the molten salt electrolyte such that the granules or particles are submerged within the molten salt electrolyte.

In another example, the first material (e.g., Ca), second material (e.g., Sb and Fe, steel, or SS), and the electrolyte (e.g., molten salt comprising calcium chloride, potassium chloride, lithium chloride, etc.) may be pre-reacted to form a mixture of the first material, second material and salt (e.g., Ca—Sb—Li and a mixture of the first material, second material, salt, and iron, steel, or stainless steel (e.g., Ca—Sb—Li—Fe/SS) alloy intermixed with salt. The mixtures may be processed to generate powder or granules and the powder or granules may be added to the one or more bays of the cell housing. Alternatively, or in addition to, the pre-reacted mixture may generate a slurry with the molten salt and the slurry may be added to the one or more bays. The cell may be filled with the molten salt electrolyte such that the granules or particles are submerged within the molten salt electrolyte.

The molten salt electrolyte may be delivered to the cell via a positive pressure stream or by pulling a vacuum on the cell connected to a molten salt bath via a hollow tube. A volume of molten electrolyte may be added to the cell housing such that an empty headspace above the reactive materials of the electrochemical cell is less than or equal to about 2.5 centimeters (cm). The empty headspace may be less than or equal to about 2.5 cm, 2 cm, 1.5 cm, 1 cm, 0.5 cm, 0.1 cm, or less. In an example, the empty headspace is less than or equal to about 1 cm. In another example, the empty headspace is less than or equal to about 0.5 cm. In another example, the headspace may be from about 0.1 cm to 1 cm.

The cell housing may include an aperture and a conductor may be inserted through the aperture and into the electrolyte within the cell housing. The cell housing may be sealed around the conductor. The cell housing and conductor may be sealed by any of the seals described in PCT Application No. PCT/US2013/065086, filed Oct. 15, 2013, PCT Application No. PCT/US2014/060979, filed Oct. 16, 2014, PCT Application No. PCT/US2016/021048, filed Mar. 4, 2016, and PCT Application No. PCT/US2017/050544, filed Sep. 7, 2017, each of which is entirely incorporated herein by reference.

### Energy Storage Systems

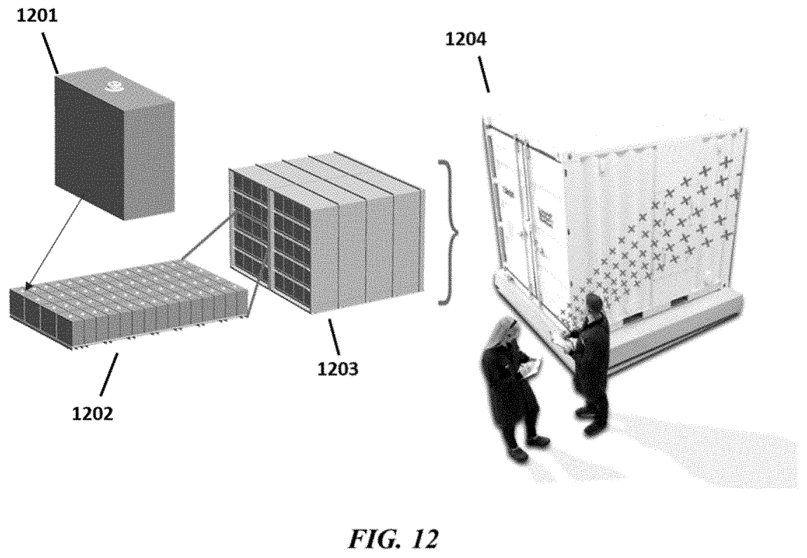

An energy storage system may be designed to include tens to hundreds of cells connected in a series, parallel, or combination of series and parallel configuration. FIG. 12 shows an example system comprising a plurality of cells within an insulated container. A plurality of cells 1201 may be assembled and arranged onto trays 1202. The trays may have greater than or equal to 1, 2, 4, 6, 8, 10, 20, 40, 60, 80, 100, or more cells. The trays may be stacked inside of racks to create towers of cells 1203. A tower may have greater than or equal to 1, 2, 4, 6, 8, 10, 20, 40, or more trays. The towers of cells 1203 may be disposed inside a thermally insulated container 1204. The energy density of the system may be increased by reducing the thickness of components (e.g., cell walls, metal separators, etc.), reducing inter-electrode spacing, and/or minimizing the height of the empty headspace within a cell.

An energy storage system may store greater than or equal to about 10 kilowatt hour (kWh), 20 kWh, 30 kWh, 40 kWh, 50 kWh, 75 kWh, 100 kWh, 150 kWh, 200 kWh, 300 kWh, 400 kWh, 500 kWh, 600 kWh, 800 kWh, 1000 kWh, 1200 kWh, 1400 kWh, 1600 kWh, 1800 kWh, 2000 kWh, or more power within a ten foot shipping container. In an example, the energy storage system may store greater than or equal to about 400 kWh of power within a ten foot shipping container. In another example, the energy storage system may store greater than or equal to about 1000 kWh of power within a ten foot shipping container.

The system may be shipped cold (e.g., at ambient temperature) and once installed, energy may be provided to initially heat up the cells to their operating temperature. Heating the cells from an ambient temperature to the operating temperature may use three to four times the amount of energy stored by the cells. Once the system is heated and in operation, the charge and discharge process may generate heat and maintains the temperature of the system. For example, for cells that are operated at a rate that results in a DC-DC efficiency of 80%, approximately 20% of the energy capacity of the cell may be released as heat within the thermally enclosed chamber during each charge/discharge cycle. In an example, a 1 megawatt hour (MWh) container operating at 80% DC-DC efficiency may generate 200 kWh of head during a cycle.

The container housing the plurality of cells may be thermally insulated. The thermal insulation may be configured such that sufficient heat is retained from the charge/discharge cycle that the system is self-heated when cycled once every one to two days. The system may be configured to be self-heated when the system is cycled at least once every 4 hrs, 8 hrs, 12 hrs, 16 hrs, 20 hrs, 1 day, 1.5 days, 2 days, 3 days, 4 days, or more. The system may also include one or more internal flow channels configured to direct air within the system to remove excess heat. The air may passively flow through the channels (e.g., via natural convection) or may actively flow through the channels (e.g., the air may be directed by a pump or other flow generating device).

As the described electrochemical cells and systems may not use pumps or mechanical systems to accept or return stored energy, the system may instantly or nearly instantly alternative between charging and discharging, thereby responding rapidly to the demands from grid operators and/or industrial customers. The response time of the system may be limited by the quality o the power electronics and control systems and may not be limited by the electrochemical cells. For example, an electrochemical cell may be switchable from full charging to full discharging in less than or equal to 100 milliseconds (ms), 80 ms, 60 ms, 40 ms, 30 ms, 20 ms, 10 ms, 8 ms, 6 ms, 4 ms, 3 ms, 2 ms, 1 ms, or less. In an example, and electrochemical cell may be switchable from full charging to full discharging in less than or equal to 8 ms.

Despite the high operating temperature of the energy storage system, the Ca∥Sb cell chemistry may have safety advantages compared to other cell chemistries. For example, overcharging lithium-ion batteries can be catastrophic, resulting in electrolyte decomposition and off-gassing, pressure build-up, thermal runaway events, and/or fires. Thus, lithium-ion batteries may use sensitive control systems to prevent such instances from occurring. By comparison, overcharging a Ca∥Sb cell by 200% or more may not pose a safety risk. For example, unlike other batteries that use organic electrolytes that may ignite when exposed to heat and air, the electrolyte in a Ca∥Sb may be non-flammable. Additionally, the electrolyte in the Ca∥Sb may have a wide electrochemical window such that overcharging may not result in electrolyte decomposition or gas formation, thereby avoiding over-pressurization of the cell due to overcharging. Furthermore, overcharging and/or internal shorting of the cell may not lead to thermal runaway.

The electrochemical cell components may have a high thermal mass. The high thermal mass combined with a cell voltage on the order of one volt may permit less energy to be stored per unit mass of cell comparted to other cell chemistries. As such, the energy stored within the cell may be insufficient to raise the cell temperature to above the melting point of the housing (e.g., stainless steel container) or boil components with in the cell, thus increasing the safety of the electrochemical cell. Additionally, the Ca∥Sb cells may be processed and disposed of as non-hazardous waste, based on the low toxicity of cell chemicals. The safety characteristics of the Ca∥Sb may simplify the system design elements. By avoiding thermal runaway, the energy storage system may be built and operate using large-capacity cells with packs disposed close together. The system may also avoid using heating, ventilation, and air conditioning systems (HVAC) and fire extinguishing systems. Also, due to the increase in cell capacity, the battery management system may have fewer cells to monitor and balance than a system with lower-capacity cells.

### Computer Systems

The present disclosure provides computer systems (e.g., control systems) that are programmed to implement methods of the disclosure, such as to control operation of an energy storage device with one or more electrochemical energy storage cells. The energy storage device may be coupled to a computer system that regulates the charging and/or discharging of the device. The computer system may include one or more computer processors and a memory location coupled to the computer processor. The memory location may comprise machine-executable code that, upon execution by the computer processor, implements any of the methods described elsewhere herein.

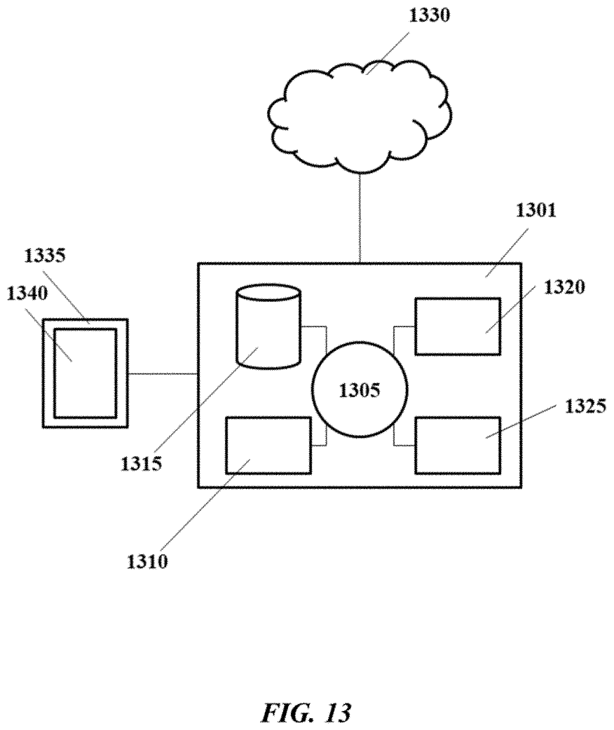

FIG. 13 shows a system 1301 that is programmed or otherwise configured to control or regulate one or more process parameters of an energy storage system of the present disclosure. The system 1301 can regulate various aspects of the various methods of the present disclosure, such as, for example, regulating temperature, charge and/or discharge of the energy storage device, and/or other battery management system. The computer system 1301 can be an electronic device of a user or a computer system that is remotely located with respect to the electronic device. The electronic device can be a mobile electronic device.

The computer system 1301 includes a central processing unit (CPU, also “processor” and “computer processor” herein) 1305, which can be a single core or multi core processor, or a plurality of processors for parallel processing. The computer system 1301 also includes memory or memory location 1310 (e.g., random-access memory, read-only memory, flash memory), electronic storage unit 1315 (e.g., hard disk), communication interface 1320 (e.g., network adapter) for communicating with one or more other systems, and peripheral devices 1325, such as cache, other memory, data storage and/or electronic display adapters. The memory 1310, storage unit 1315, interface 1320 and peripheral devices 1325 are in communication with the CPU 1305 through a communication bus (solid lines), such as a motherboard. The storage unit 1315 can be a data storage unit (or data repository) for storing data. The computer system 1301 can be operatively coupled to a computer network (“network”) 1330 with the aid of the communication interface 1320. The network 1330 can be the Internet, an internet and/or extranet, or an intranet and/or extranet that is in communication with the Internet. The network 1330 in some cases is a telecommunication and/or data network. The network 1330 can include one or more computer servers, which can enable distributed computing, such as cloud computing. The network 1330, in some cases with the aid of the computer system 1301, can implement a peer-to-peer network, which may enable devices coupled to the computer system 1301 to behave as a client or a server.

The CPU 1305 can execute a sequence of machine-readable instructions, which can be embodied in a program or software. The instructions may be stored in a memory location, such as the memory 1310. The instructions can be directed to the CPU 1305, which can subsequently program or otherwise configure the CPU 1305 to implement methods of the present disclosure. Examples of operations performed by the CPU 1305 can include fetch, decode, execute, and writeback.

The CPU 1305 can be part of a circuit, such as an integrated circuit. One or more other components of the system 1301 can be included in the circuit. In some cases, the circuit is an application specific integrated circuit (ASIC).

The storage unit 1315 can store files, such as drivers, libraries and saved programs. The storage unit 1315 can store user data, e.g., user preferences and user programs. The computer system 1301 in some cases can include one or more additional data storage units that are external to the computer system 1301, such as located on a remote server that is in communication with the computer system 1301 through an intranet or the Internet.

The computer system 1301 can communicate with one or more remote computer systems through the network 1330. For instance, the computer system 1301 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1301 via the network 1330.

Methods as described herein can be implemented by way of machine (e.g., computer processor) executable code stored on an electronic storage location of the computer system 1301, such as, for example, on the memory 1310 or electronic storage unit 1315. The machine executable or machine readable code can be provided in the form of software. During use, the code can be executed by the processor 1305. In some cases, the code can be retrieved from the storage unit 1315 and stored on the memory 1310 for ready access by the processor 1305. In some situations, the electronic storage unit 1315 can be precluded, and machine-executable instructions are stored on memory 1310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1301 can include or be in communication with an electronic display 1335 that comprises a user interface (UI) 1340 for providing, for example, status of the energy storage device or controls for the energy storage device. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. The algorithm can, for example, control the battery management system and/or maintain or control the temperature, charge, and/or discharge of the energy storage device.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-64. (canceled)

65. An energy storage device, comprising:
a first electrode comprising a first material;
a second electrode comprising a second material different than said first material, wherein said second material comprises antimony and one or more members selected from the group consisting of iron, steel, and stainless steel; and
an electrolyte disposed between said first electrode and said second electrode, wherein said electrolyte is configured to conduct ions of said first material.

66. The energy storage device of claim 65, wherein said first electrode comprises calcium.

67. The energy storage device of claim 66, wherein said first electrode comprises an alloy of calcium and lithium.

68. The energy storage device of claim 65, wherein said second electrode comprises an iron-antimony alloy.

69. The energy storage device of claim 65, wherein said second electrode comprises a steel-antimony alloy.

70. The energy storage device of claim 65, wherein said second electrode comprises a stainless steel-antimony alloy.

71. The energy storage device of claim 65, wherein, during discharge, said second electrode forms particles comprising (i) calcium, lithium, and antimony and (ii) one or more members selected from the group consisting of iron, steel, and stainless steel during discharge.

72. The energy storage device of claim 65, wherein said electrolyte comprises one or more members selected from the group consisting of calcium chloride, lithium chloride, and potassium chloride.

73. The energy storage device of claim 65, wherein said electrolyte is a molten salt electrolyte.

74. The energy storage device of claim 65, wherein said first electrode is at least partially liquid at an operating temperature of said energy storage device.

75. The energy storage device of claim 74, wherein said operating temperature is greater than or equal to 250° C.

76. The energy storage device of claim 65, wherein said second electrode comprises solid particles of said second material.

77. The energy storage device of claim 76, wherein said solid particles of said second material are submerged in said electrolyte.

78. The energy storage device of claim 77, wherein said energy storage device further comprises a cell housing configured to hold said first electrode, said second electrode, and said electrolyte, and wherein said cell housing comprises a permeable metal separator configured to retain said second electrode.

79. The energy storage device of claim 65, further comprising a plurality of first electrodes comprising said first electrode.

80. The energy storage device of claim 79, wherein said first electrode of said plurality of first electrodes and another first electrode of said plurality of first electrodes are disposed parallel to one another.

81. The energy storage device of claim 65, wherein a gap between said first electrode and said second electrode is less than or equal to about 10 millimeters (mm).

82. The energy storage device of claim 65, wherein said first electrode is disposed in a negative current collector, and wherein said negative current collector comprises a porous metallic structure.
